(19) United States
(12) Patent Application Publication
(10) Pub. No.: US 2016/0006917 A1
(43) Pub. Date: Jan. 7, 2016

(54) IMAGING DEVICE AND METHOD OF DRIVING IMAGING DEVICE

(71) Applicant: CANON KABUSHIKI KAISHA, Tokyo (JP)

(72) Inventor: Toshiaki Endo, Yokohama-shi (JP)

(21) Appl. No.: 14/748,757

(22) Filed: Jun. 24, 2015

(30) Foreign Application Priority Data
Jul. 1, 2014 (JP) 2014-135890

(51) Int. Cl. H04N 5/235; H04N 5/353; H04N 5/378; H04N 5/208

(52) U.S. Cl. CPC H04N 5/2353; H04N 5/208; H04N 5/353; H04N 5/378

(57) ABSTRACT

An imaging device includes a pixel including a first photoelectric conversion element, a second photoelectric conversion element, and a microlens commonly provided for the first and the second photoelectric conversion elements, a read-out circuit configured to reset the first and the second photoelectric conversion elements, read out a first focal point detection signal based on signal charges generated in the first photoelectric conversion element, and read out, after the first focal point detection signal is read out, a second focal point detection signal based on signal charges generated in at least the second photoelectric conversion element, and a correction unit configured to correct at least one of the first and the second focal point detection signals in accordance with a time difference between a timing of the read-out of the first focal point detection signal and a timing of the read-out of the second focal point detection signal.

### BACKGROUND OF THE INVENTION

1. Field of the Invention

The present invention relates to an imaging device for performing focal point detection on an imaging plane, and a method of driving the imaging device.

2. Description of the Related Art

There is known an imaging device that performs pupil-division type focal point detection using an image sensor in which a microlens is formed in each pixel. In this image sensor, each pixel is formed by a photoelectric conversion element A and a photoelectric conversion element B. At the time of focal point detection, signals are independently read out from the photoelectric conversion elements A and the photoelectric conversion elements B of a plurality of pixels, and used as focal point detection signals. Furthermore, at the time of imaging, a signal obtained by adding a signal read out from the photoelectric conversion element A and a signal read out from the photoelectric conversion element B is read out from each pixel, and used as an image forming signal.

At the time of rolling driving of a CMOS image sensor, a read-out time difference occurs between the signals of the divided focal point detection pixels. Especially, when using an electronic shutter whose shutter speed is high (for example, 1/10,000 sec), the ratio of the read-out time difference to the accumulation time becomes too large to ignore, thereby causing an output level difference between the focal point detection signals. This output level difference is an error in phase difference between the detection signals, thereby impairing the focal point detection accuracy.

### SUMMARY OF THE INVENTION

An object of the present invention is to provide an imaging device capable of improving the focal point detection accuracy by correcting an error in phase difference caused by the read-out time difference between focal point detection signals, and a method of driving the imaging device.

According to one aspect of the present invention, there is provided an imaging device including a pixel including a first photoelectric conversion element, a second photoelectric conversion element, and a microlens commonly provided for the first photoelectric conversion element and the second photoelectric conversion element, a read-out circuit configured to reset the first photoelectric conversion element and the second photoelectric conversion element, read out a first focal point detection signal based on signal charges generated in the first photoelectric conversion element, and read out, after the first focal point detection signal is read out, a second focal point detection signal based on signal charges generated in at least the second photoelectric conversion element, and a correction unit configured to correct at least one of the first focal point detection signal and the second focal point detection signal in accordance with a time difference between a timing of the read-out of the first focal point detection signal and a timing of the read-out of the second focal point detection signal.

According to another aspect of the present invention, there is provided a method of driving an imaging device having a pixel including a first photoelectric conversion element, a second photoelectric conversion element, and a microlens configured to focus incident light on the first photoelectric conversion element and the second photoelectric conversion element, the method including resetting the first photoelectric conversion element and the second photoelectric conversion element, reading out a first focal point detection signal based on signal charges generated in the first photoelectric conversion element, reading out, after the first focal point detection signal is read out, a second focal point detection signal based on signal charges generated in at least the second photoelectric conversion element, and correcting at least one of the first focal point detection signal and the second focal point detection signal in accordance with a time difference between a timing of the read-out of the first focal point detection signal and a timing of the read-out of the second focal point detection signal.

According to further another aspect of the present invention, there is provided an imaging device including a pixel including a first photoelectric conversion element configured to generate a first charge by photoelectric conversion, a second photoelectric conversion element configured to generate a second charge by photoelectric conversion, an amplifier transistor, a first transfer transistor configured to be connected to the first photoelectric conversion ant the amplifier transistor, a second transfer transistor configured to be connected to the second photoelectric conversion element and the amplifier transistor, and a microlens commonly provided for the first photoelectric conversion element and the second photoelectric conversion element, a read-out circuit configured to reset the first photoelectric conversion element and the second photoelectric conversion element, transfer the first charge from the first photoelectric conversion element to the amplifier transistor via the first transfer transistor, and transfer, after the first charge from the first photoelectric conversion element is transferred to the amplifier transistor, the second charge from the second photoelectric conversion element to the amplifier transistor via the second transfer transistor, and a correction unit configured to correct at least one of a first signal based on the first charge and a second signal based on the second charge in accordance with a time difference between a timing of transferring the first charge from the first photoelectric conversion element to the amplifier transistor and a timing of transferring the second charge from the second photoelectric conversion element to the amplifier transistor.

Further features of the present invention will become apparent from the following description of exemplary embodiments with reference to the attached drawings.

### BRIEF DESCRIPTION OF THE DRAWINGS

FIG. 1 is a block diagram illustrating an arrangement of an imaging device according to a first embodiment of the present invention.

FIG. 2 is a schematic view illustrating the arrangement of the solid-state imaging element of the imaging device according to the first embodiment of the present invention.

FIG. 3A is a plan view illustrating an arrangement of a pixel unit of the solid-state imaging element of the imaging device according to the first embodiment of the present invention.

FIG. 3B is a cross-sectional view illustrating the arrangement of the pixel unit of the solid-state imaging element of the imaging device according to the first embodiment of the present invention.

FIG. 4 is a timing chart illustrating a method of driving the imaging device according to the first embodiment of the present invention.

FIG. 5 is a timing chart illustrating the method of driving the imaging device according to the first embodiment of the present invention.

FIGS. 6A and 6B are graphs illustrating a phase difference detection processing method based on focal point detection signals.

FIG. 7 is a flowchart illustrating the method of driving the imaging device according to the first embodiment of the present invention.

FIG. 8 is a timing chart illustrating a method of driving the imaging device according to a modification of the first embodiment of the present invention.

FIG. 9 is a circuit diagram illustrating an arrangement of an amplification unit of a solid-state imaging element of an imaging device according to a second embodiment of the present invention.

FIG. 10 is a timing chart illustrating a method of driving an imaging device according to a third embodiment of the present invention.

### DESCRIPTION OF THE EMBODIMENTS

### First Embodiment

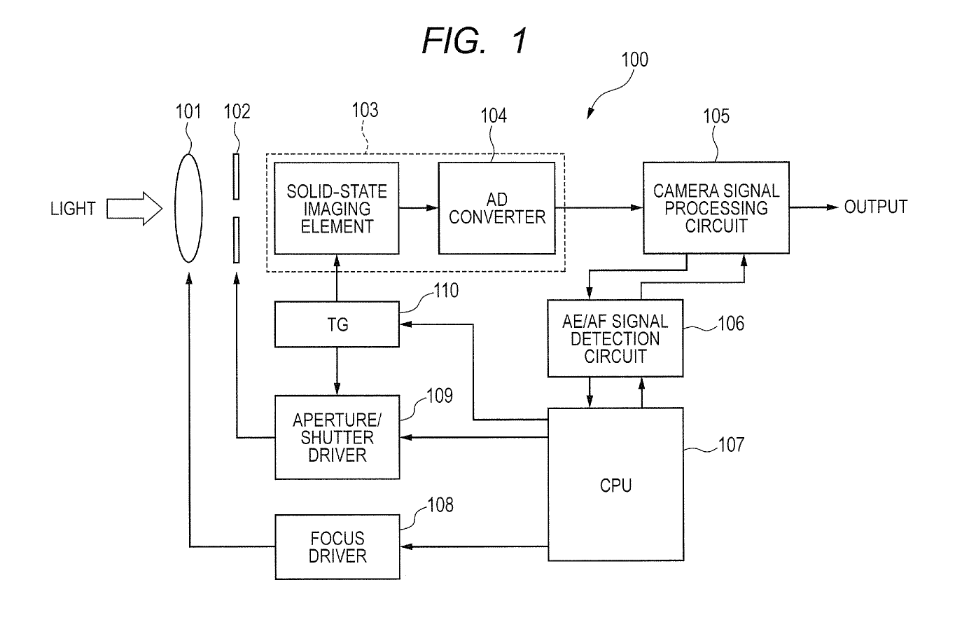

An imaging device and a method of driving the imaging device according to a first embodiment of the present invention will be described with reference to FIGS. 1 to 8.

FIG. 1 is a block diagram illustrating an example of an arrangement of an imaging device according to the present embodiment. An imaging device 100 includes, for example, a lens 101, an aperture/shutter unit 102, a solid-state imaging element 103, a camera signal processing circuit 105, an AE/AF signal detection circuit 106, a CPU 107, a focus driver 108, an aperture/shutter driver 109, and a timing generator (TG) 110. The solid-state imaging element 103 is, for example, a CMOS image sensor, and includes an A/D converter 104.

An optical system including the lens 101 and the aperture/shutter unit 102 images light from an object on an imaging region of the solid-state imaging element 103, thereby forming an image of the object. At a timing based on a signal from the TG 110, the solid-state imaging element 103 acquires a signal corresponding to the light imaged on a pixel array unit as the imaging region, and outputs a digital signal converted from an analog signal by the A/D converter 104.

The digital signal output from the solid-state imaging element 103 is processed by the camera signal processing circuit 105 as an image forming signal and focal point detection signal. The camera signal processing circuit 105 also has a function of performing gain correction of the output value of the focal point detection signal. The AE/AF signal detection circuit 106 performs phase difference detection based on the image forming signal and focal point detection signal processed by the camera signal processing circuit 105, and calculates AF information for controlling the focus and AE information for controlling exposure.

The CPU 107 comprehensively controls the operation of the imaging device 100, and controls driving of the focus driver 108, aperture/shutter driver 109, TG 110, and the like based on the output information from the AE/AF signal detection circuit 106 and the like. The TG 110 generates an electronic shutter control pulse in synchronism with a horizontal synchronization signal (HD) and vertical synchronization signal (VD).

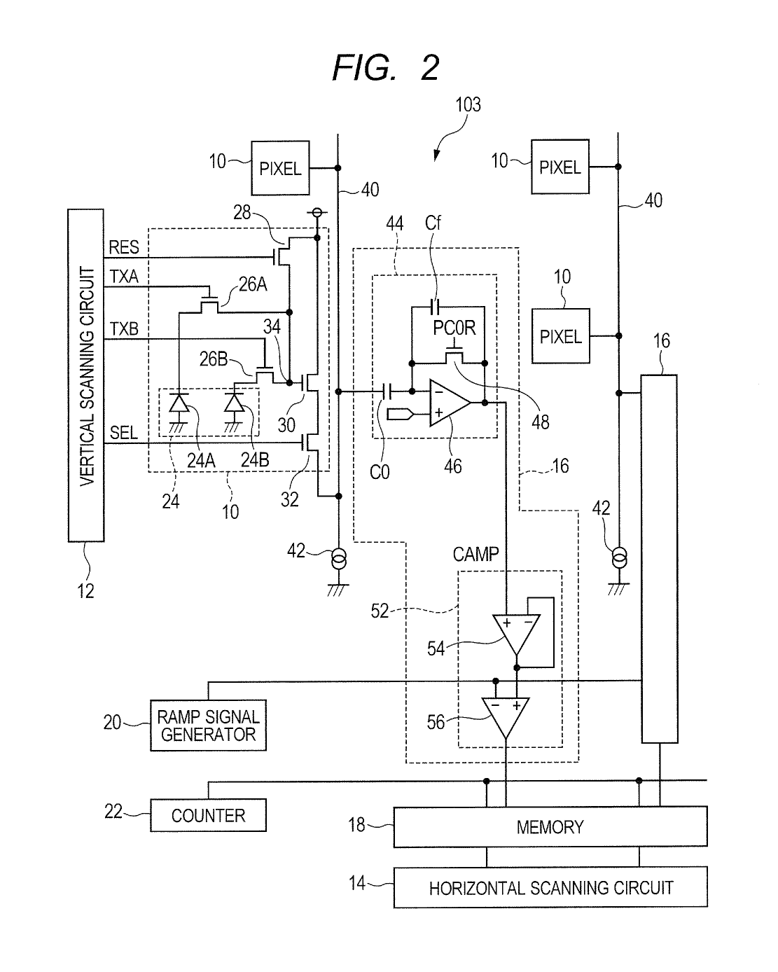

FIG. 2 is a pixel block diagram illustrating an example of the solid-state imaging element 103 according to the present embodiment. The solid-state imaging element 103 includes pixels 10, a vertical scanning circuit 12, a horizontal scanning circuit 14, a column read-out circuit 16, a memory 18, a ramp signal generator 20, and a counter 22.

The pixels 10 are arranged in a two-dimensional matrix in the row and column directions, thereby forming the pixel array serving as the imaging region. FIG. 2 illustrates only 2×2 pixels 10 for the sake of simplicity. The number of pixels 10 arranged in the row and column directions is not specifically limited. Note that in this specification, the row direction indicates the horizontal direction in FIG. 2 and the column direction indicates the vertical direction in FIG. 2. In an example, the row direction corresponds to the horizontal direction of the imaging device and the column direction corresponds to the vertical direction of the imaging device.

Each pixel 10 is a pupil-division type focal point detection pixel including a plurality of photoelectric conversion elements. The pixel 10 includes a photoelectric conversion unit 24, transfer MOS transistors 26A and 26B, a reset MOS transistor 28, an amplifier MOS transistor 30, and a select MOS transistor 32. FIG. 2 illustrates an example of a practical circuit arrangement of only one pixel 10 for the sake of simplicity.

The photoelectric conversion unit 24 includes a plurality of photoelectric conversion elements, that is, a first photoelectric conversion element 24A and a second photoelectric conversion element 24B. Each of the photoelectric conversion elements 24A and 24B is formed from a photodiode but may be any kind of element which can convert light into charges. The photoelectric conversion element 24A has an anode connected to a ground voltage line, and a cathode connected to a source of the transfer MOS transistor 26A. The second photoelectric conversion element 24B has an anode connected to the ground voltage line, and a cathode connected to a source of the transfer MOS transistor 26B. Drains of the transfer MOS transistors 26A and 26B are connected to a source of the reset MOS transistor 28 and a gate of the amplifier MOS transistor 30. The connection node of the drains of the transfer MOS transistors 26A and 26B, the source of the reset MOS transistor 28, and the gate of the amplifier MOS transistor 30 forms a floating diffusion region (to be referred to as an “FD region” hereinafter) 34. Drains of the reset MOS transistor 28 and the amplifier MOS transistor 30 are connected to a power supply voltage line. A source of the amplifier MOS transistor 30 is connected to a drain of the select MOS transistor 32. The transfer MOS transistors 26A and 26B, reset MOS transistor 28, amplifier MOS transistor 30, and select MOS transistor 32 form an intra-pixel read-out circuit for reading out a pixel signal based on charges generated in the photoelectric conversion elements 24A and 24B.

Note that the names of the source and the drain of the transistor may change depending on the conductive type or the function of interest of the transistor, and the above-described source and drain may be referred to by the opposite names.

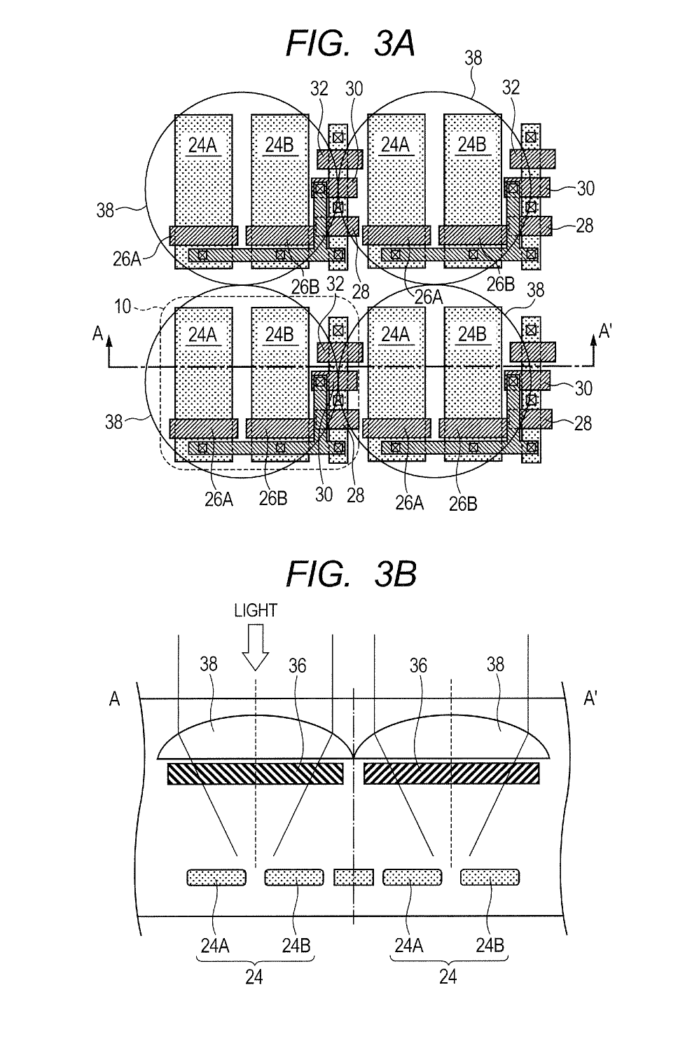

FIG. 3A is a schematic plan view illustrating the pixel array, and FIG. 3B is a cross-sectional view taken along a line A-A′ in FIG. 3A. The pixel array having the circuit arrangement illustrated in FIG. 2 is not specifically limited. For example, the pixel array can be implemented by a two-dimensional layout illustrated in FIG. 3A. Referring to FIG. 3A, a unit region surrounded by a dotted line indicates a photoelectric conversion unit, that is, a unit pixel (pixel 10). One microlens 38 is arranged over each pixel 10. As illustrated in FIG. 3B, a color filter 36 is arranged between the microlens 38 and the photoelectric conversion elements 24A and 24B.

In this specification, when collectively indicating the plurality of photoelectric conversion elements (photoelectric conversion elements 24A and 24B) of each pixel 10, a “light-receiving unit” will be used. Each microlens 38 is arranged over one corresponding photoelectric conversion unit 24, and focuses a light beam on the photoelectric conversion unit 24. That is, each microlens 38 is provided in correspondence with each photoelectric conversion unit 24. The incident light converged by each microlens 38 enters the photoelectric conversion elements 24A and 24B forming the photoelectric conversion unit 24 of the pixel 10 provided in correspondence with the microlens 38. This forms a pair of pupil-division type focal point detection pixels.

Signal lines TXA, TXB, RES, and SEL are arranged to extend in the row direction on each row of the pixel array. The signal line TXA is connected to each of the gates of the transfer MOS transistors 26A of the pixels 10 arranged in the row direction, and is common to these pixels 10. The signal line TXB is connected to each of the gates of the transfer MOS transistors 26B of the pixels 10 arranged in the row direction, and is common to these pixels 10. The signal line RES is connected to each of the gates of the reset MOS transistors 28 of the pixels 10 arranged in the row direction, and is common to these pixels 10. The signal line SEL is connected to each of the gates of the select MOS transistors 32 of the pixels 10 arranged in the row direction, and is common to these pixels 10. FIG. 2 illustrates only the signal lines TXA, TXB, RES, and SEL connected to one pixel 10 for the sake of simplicity.

The vertical scanning circuit 12 selects the pixels 10 for each row based on a predetermined timing signal from the TG 110, and causes them to output pixel signals. The signal lines TXA, TXB, RES, and SEL are connected to the vertical scanning circuit 12. The vertical scanning circuit 12 outputs, to the signal line TXA, a transfer pulse signal PTXA for driving the transfer MOS transistors 26A. The vertical scanning circuit 12 outputs, to the signal line TXB, a transfer pulse signal PTXB for driving the transfer MOS transistors 26B. The vertical scanning circuit 12 outputs, to the signal line RES, a reset pulse signal PRES for driving the reset MOS transistors 28. The vertical scanning circuit 12 outputs, to the signal line SEL, a select pulse signal PSEL for driving the select MOS transistor 32. Assume that if a signal of high level is applied to each of the signal lines, the corresponding transistors are rendered conductive (turned on). If a signal of low level is applied, the corresponding transistors are rendered non-conductive (turned off).

A vertical signal line 40 is arranged to extend in the column direction on each column of the pixel array. The vertical signal line 40 is connected to each of the sources of the select MOS transistors 32 of the pixels 10 arranged in the column direction, and is common to these pixels 10. The column read-out circuit 16 and a current source 42 are connected to the vertical signal line 40 on each column.

The column read-out circuit 16 is used to process the signals read out from the pixels 10. As illustrated in FIG. 2, the column read-out circuit 16 includes an amplification unit 44 and an A/D conversion unit 52. Note that the A/D conversion units 52 provided on the respective columns correspond to the A/D converter 104 illustrated in FIG. 1.

The amplification unit 44 includes an operational amplifier (differential amplifier) 46, a switch 48, an input capacitor C0, and a load capacitor Cf. The inverting input terminal of the operational amplifier 46 is connected to the vertical signal line 40 via the input capacitor C0. A reference voltage is applied to the non-inverting input terminal of the operational amplifier 46. The load capacitor Cf and the switch 48 are connected in parallel between the inverting input terminal and the output terminal of the operational amplifier 46. The switch 48 is driven by a signal PC0R applied to a control node. In this example, when the signal PC0R is at high level, the switch is rendered conductive (turned on). When the signal PC0R is at low level, the switch 48 is rendered non-conductive (turned off).

The A/D conversion unit 52 includes an operational amplifier 54 forming a buffer circuit, and an operational amplifier 56 forming a comparator. The non-inverting input terminal of the operational amplifier 54 is connected to the output terminal of the operational amplifier 46. The inverting input terminal of the operational amplifier 54 is connected to the output terminal of the operational amplifier 54. The output terminal of the operational amplifier 54 is connected to the non-inverting input terminal of the operational amplifier 56. The inverting input terminal of the operational amplifier 56 is connected to the ramp signal generator 20. The memory 18 is connected to the output terminal of the operational amplifier 56. The horizontal scanning circuit 14 and counter 22 are connected to the memory 18.

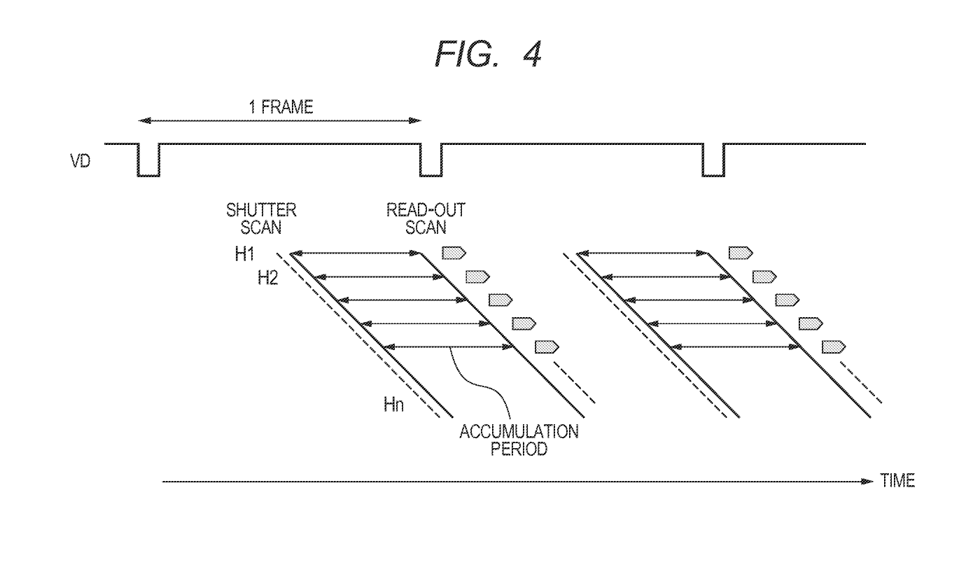

Next, a method of driving imaging device according to the present embodiment will be described with reference to FIGS. 1 to 7. The method of driving the imaging device according to the present embodiment sequentially performs a shutter scan and read-out scan with reference to the vertical synchronization signal VD for each row of the solid-state imaging element 103, as illustrated in FIG. 4. In the shutter scan, charges held in the photoelectric conversion elements 24A and 24B of the plurality of pixels 10 belonging to the row are reset sequentially for each row. In the read-out scan, a signal based on the charges accumulated in the photoelectric conversion elements 24A and 24B is read out from each of the plurality of pixels 10 belonging to the row sequentially for each row. A time from the start of the shutter scan to the start of the read-out scan is the accumulation period of signal charges in the photoelectric conversion elements 24A and 24B.

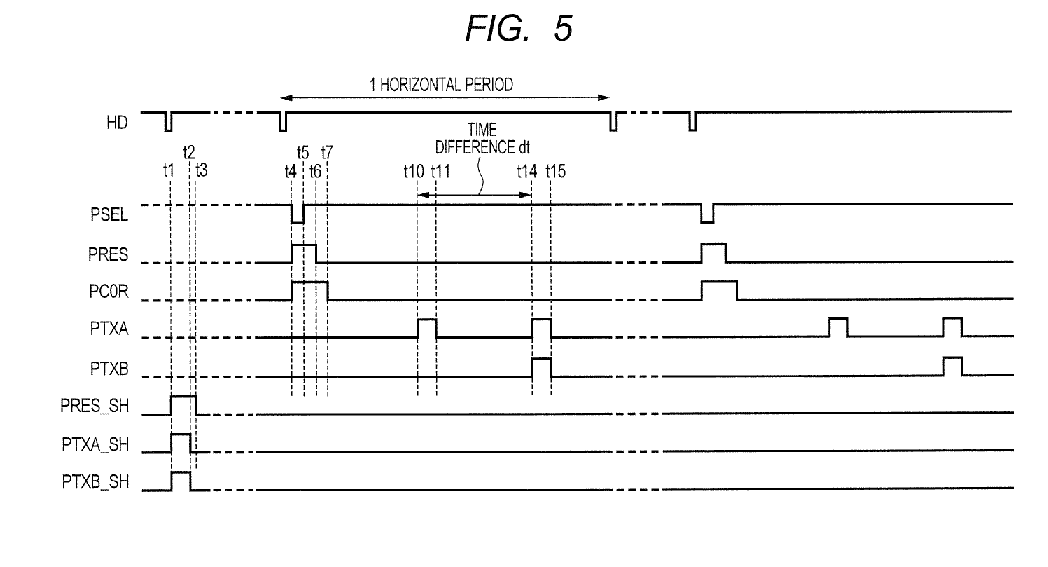

A read-out operation for each row will be described in more detail with reference to a timing chart illustrated in FIG. 5. Referring to FIG. 5, the above-described shutter scan operation approximately corresponds to a period from time t1 to time t3. The above-described read-out scan operation approximately corresponds to a period from time t10 to time t15.

At time t1, in synchronism with the horizontal synchronization signal HD, signals PRES_SH, PTXA_SH, and PTXB_SH are set at high level to turn on the reset MOS transistors 28 and the transfer MOS transistors 26A and 26B. This removes charges accumulated in the photoelectric conversion elements 24A and 24B via the transfer MOS transistors 26A and 26B and the reset MOS transistors 28. That is, the reset operation of the photoelectric conversion elements 24A and 24B is performed. In this way, the driving method according to the present embodiment simultaneously resets the photoelectric conversion elements 24A and 24B by electronic shutter pulses (signals PRES_SH, PTXA_SH, and PTXB_SH).

When performing electronic shutter driving, the pixels 10 are reset prior to a read-out scan, as described above. Note that the photoelectric conversion elements 24A and 24B are actually reset by the signals PRES, PTXA, and PTXB. In a timing chart illustrated in FIG. 5, these signals are represented by the signals PRES_SH, PTXA_SH, and PTXB_SH to discriminate the reset driving pulses of the electronic shutter.

At time t2, the signals PTXA_SH and PTXB_SH are set at low level to turn off the transfer MOS transistors 26A and 26B. At this timing, the reset operation of the photoelectric conversion elements 24A and 24B ends and the charge accumulation period of the photoelectric conversion elements 24A and 24B starts.

After the transfer MOS transistors 26A and 26B are turned off, at time t3 the signal PRES_SH is set at low level to turn off the reset MOS transistors 28. This completes a series of shutter scan operations.

In this state, after charges are accumulated in the photoelectric conversion elements 24A and 24B for a predetermined period, a signal based on the charges accumulated in the photoelectric conversion elements 24A and 24B is read out from each of the pixels 10 for each row or a plurality of rows. That is, a read-out scan is performed.

In synchronism with the horizontal synchronization signal HD, at time t4, the signal PRES is set at high level to turn on each reset MOS transistor 28. This electrically connects the FD region 34 serving as the input node of the amplifier MOS transistor 30 to the power supply voltage line via the reset MOS transistor 28, thereby resetting the input node of the corresponding amplifier MOS transistor 30 to the potential of a reset level.

Similarly, at time t4, the signal PC0R is set at high level to render each switch 48 conductive. This short-circuits the output terminal and inverting input terminal of the operational amplifier 46, thereby setting the operational amplifier 46 in a buffer state.

At time t5, the signal PSEL is set at high level to turn on each select MOS transistor 32. This causes each current source 42 to supply a bias current to the source of the amplifier MOS transistor 30 via the vertical signal line 40, thereby forming a source follower circuit. This outputs, to each column read-out circuit 16 via the select MOS transistor 32 and vertical signal line 40, a signal (reset signal) when the input node of the amplifier MOS transistor 30 is at the potential of the reset level. The reset signal input to the column read-out circuit 16 is input, via the input capacitor C0, to the inverting input terminal of the operational amplifier 46 in a state in which the output of the reference voltage is buffered.

At time t6, the signal PRES is set at low level to turn off each reset MOS transistor 28. This cancels the reset operation of the input node of the amplifier MOS transistor 30.

At time t7, the signal PC0R is set at low level to render each switch 48 non-conductive. This connects the load capacitor Cf to the feedback path of the operational amplifier 46, thereby outputting, from the output terminal of the operational amplifier 46, the reset signal amplified according to a gain decided based on the ratio (C0/Cf) between the input capacitor C0 and the load capacitor Cf.

At time t10, the signal PTXA is set at high level to turn on each transfer MOS transistor 26A. This transfers, to the FD region 34, signal charges generated by photoelectric conversion in the photoelectric conversion element 24A during the charge accumulation period. A pixel signal based on the potential of the input node of the amplifier MOS transistor 30, which corresponds to the amount of signal charges transferred from the photoelectric conversion element 24A, is output to the vertical signal line 40 via the select MOS transistor 32.

After each pixel 10 outputs the pixel signal to the column read-out circuit 16 via the vertical signal line 40, the signal PTXA is set at low level at time t11. The operational amplifier 46 amplifies the pixel signal input from the pixel 10 via the input capacitor C0 in accordance with the gain decided based on the ratio (C0/Cf) between the input capacitor C0 and the load capacitor Cf, and outputs the amplified pixel signal from the output terminal. This pixel signal will be referred to as an “A signal” hereinafter.

At time t14, the signals PTXA and PTXB are set at high level to turn on the transfer MOS transistors 26A and 26B. This transfers, to each FD region 34, signal charges generated by photoelectric conversion in the photoelectric conversion elements 24A and 24B. As a result, a pixel signal based on the potential of the input node of the amplifier MOS transistor 30, which corresponds to the total amount of signal charges in the photoelectric conversion elements 24A and 24B, is output to the vertical signal line 40 via the select MOS transistor 32.

After each pixel 10 outputs the pixel signal to the column read-out circuit 16 via the vertical signal line 40, the signals PTXA and PTXB are set at low level at time t15. Each operational amplifier 46 amplifies the pixel signal input from the pixel 10 via the input capacitor C0 in accordance with the gain decided based on the ratio (C0/Cf) between the input capacitor C0 and the load capacitor Cf and outputs the amplified pixel signal from the output terminal. This pixel signal will be referred to as an “A+B signal” hereinafter.

The reset signal, A signal, and A+B signal output from the amplification unit 44 are converted into digital signals by the A/D conversion unit 52, and accumulated in the memory 18. The digital signals of each column accumulated in the memory 18 are sequentially read out according to a control signal from the horizontal scanning circuit 14. If the column read-out circuit 16 includes no A/D conversion unit 52, the signals of each column are sequentially read out via an output amplifier or buffer.

As focal point detection signals, the read-out A signal based on the signal charges in the photoelectric conversion element 24A and a read-out B signal based on the signal charges in the photoelectric conversion element 24B are used. The B signal is calculated by subtracting the A signal from the signal (A+B signal) based on the signal charges in the photoelectric conversion elements 24A and 24B.

However, as illustrated in FIG. 5, the time (time t10 to time t11) at which the A signal is acquired is different from that (time t14 to time t15) at which the A+B signal is acquired. Also, during a period from when the signal charges of the photoelectric conversion element 24A are transferred to the FD region 34 until signal charges of the photoelectric conversion elements 24A and 24B are transferred to the FD region 34, the input node of the amplifier MOS transistor 30 is not reset. Therefore, there is a time difference dt between the exposure time of the photoelectric conversion elements 24A and 24B until the A signal is acquired and that until the A+B signal is acquired (see FIG. 5).

A signal component corresponding to signal charges generated by photoelectric conversion in the photoelectric conversion elements 24A and 24B during the time difference dt is superimposed on the A+B signal read out from time t14 to time t15. As described above, if the driving timing at the time of reading out the A signal is different from that at the time of reading out the A+B signal, an error may occur in focal point detection position.

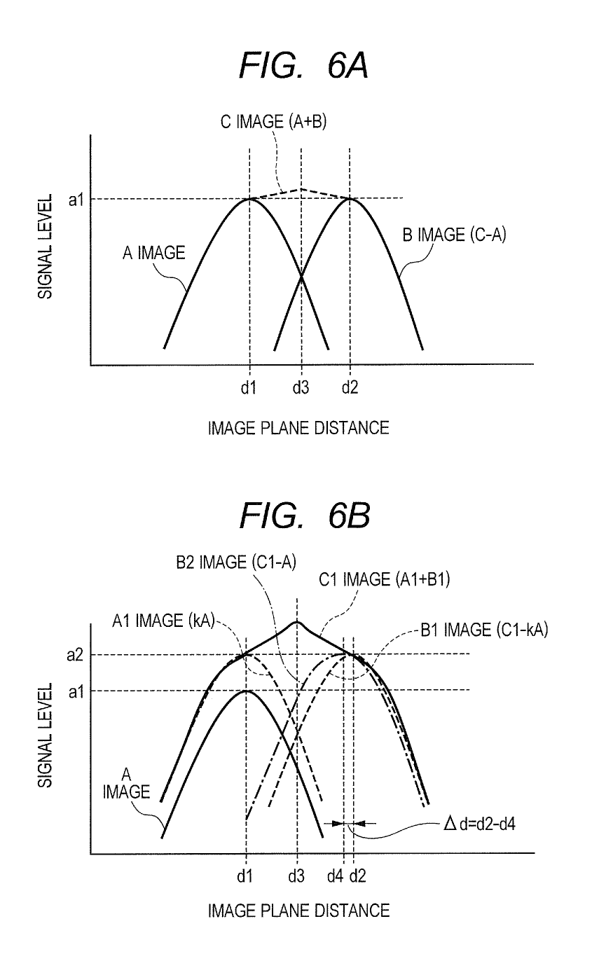

A focal point detection error caused by the difference between focal point detection signal acquisition timings will be described in more detail with reference to FIGS. 6A and 6B. Note that the A+B signal including the signal component superimposed due to the time difference dt will be referred to as an “A1+B1 signal” hereinafter.

It is possible to obtain information about the intensity distribution of a pair of images from phase detection signals (A signals and A+B signals) of the plurality of pixels 10 of the focal point detection region of the imaging region. It is possible to detect the image shift amount by performing correlation calculation and phase difference detection processing for the information. Note that the A signals from the photoelectric conversion elements 24A are defined as an A image signal, and the B signals from the photoelectric conversion elements 24B are defined as a B image signal. The signal levels of the A image signal and the B image signal change depending on the structures of the photoelectric conversion elements 24A and 24B and acquisition timings. Assuming that the structures of the photoelectric conversion elements 24A and 24B are equal to each other, a case in which the signal levels change due to the difference between the acquisition timings will be considered.

FIG. 6A illustrates an example when the accumulation timing of the signal charges as the source of the A image signal coincides with that of the signal charges as the source of the B image signal. The abscissa represents the image plane distance of the imaging plane, and the ordinate represents the signal level. Assume that the signal output level of the A image signal and that of the B image signal have the equal values (a1), the signal peak position of the A image signal is an imaging plane position d1, the signal peak position of the B image signal is an imaging plane position d2, and there is a defocus of a imaging plane phase difference (d2−d1). In this case, it is possible to correctly calculate the defocus amount of imaging by correlation calculation of the imaging plane positions d2 and d1.

By adding the A image signal and the B image signal which are expressed by solid lines, the A+B signal, that is, a C image signal expressed by a dotted line in FIG. 6A is obtained. If the A image signal and C image signal can be acquired from the solid-state imaging element 103, the B image signal can be acquired by subtracting the A image signal from the C image signal, thereby performing correct focal point detection.

On the other hand, if the driving timing at the time of acquiring the A image signal is different from that at the time of acquiring the B image signal, an error may occur in focal point detection.

FIG. 6B illustrates an example when the accumulation timing of the signal charges as the source of the A image signal is different from that of the signal charges as the source of the B image signal. The abscissa represents the imaging plane distance of the imaging plane, and the ordinate represents the signal level. A signal read out from the photoelectric conversion element 24A when the time difference dt elapses after the A signal is read out from the photoelectric conversion element 24A is set as an A1 signal, and a signal read out from the photoelectric conversion element 24B is set as a B1 signal. Furthermore, an image signal generated from a plurality of A1 signals is set as an A1 image signal, and an image signal generated from a plurality of B1 signals is set as a B1 image signal. The signal level of the A1 image signal and that of the B1 image signal have a value of a2 larger than an increase a1 in signal corresponding to the time difference dt.

At this time, an (A1+B1) image signal obtained by adding the A1 image signal and B1 image signal is a C1 image signal indicated by a solid line. In this case, if a B2 image signal which is indicated by a one-dot dashed line and corresponds to a (C1−A) image signal obtained by subtracting the A image signal from the C1 image signal is acquired, the imaging plane position of the signal peak of the acquired signal is represented by d4. Consequently, this position is different from the imaging plane position d2 of the B image signal described with reference to FIG. 6A by Δd (=d2−d4). The value Δd corresponds to an error in focal point position.

To cope with this, the driving method for the imaging device according to the present embodiment acquires the A1 signal (=kA) for calculation by multiplying the A signal by a correction coefficient of a gain k (=a2/a1). The B1 image signal as a signal of (C1−kA) is calculated by using the A1 signal. The imaging plane position of the signal peak of the thus calculated B1 image signal is indicated by d2, as illustrated in FIG. 6B, thereby canceling the error Ad.

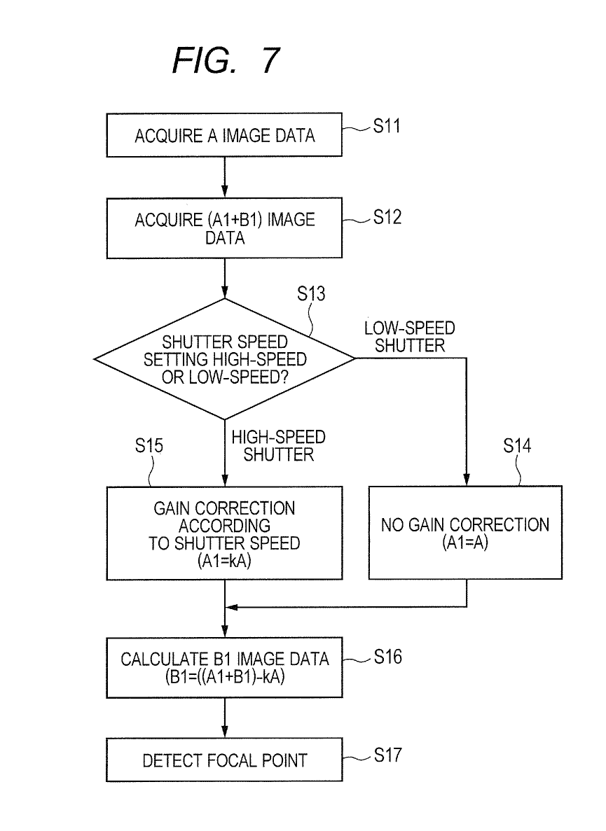

The camera signal processing circuit 105 can perform the gain correction of the focal point detection signal based on the A signal and (A1+B1) signal output from the solid-state imaging element 103 in accordance with, for example, a flowchart illustrated in FIG. 7.

In step S11, the A image signal serving as a focal point detection signal is acquired from the solid-state imaging element 103. In step S12, the (A1+B1) image signal serving as a focal point detection signal and image forming signal is acquired from the solid-state imaging element 103.

In step S13, the CPU 107 refers to the setting of the shutter speed, and determines based on the referred shutter speed whether the shutter is a low-speed shutter or high-speed shutter. If it is determined that the shutter is a low-speed shutter, the ratio of the read-out time difference dt to the accumulation time is small enough to ignore, the process transits to step S14 to set the A image signal as an A1 image signal serving as the first focal point detection signal. In this case, no gain correction is performed for the A image signal.

On the other hand, if it is determined that the shutter is a high-speed shutter, the ratio of the read-out time difference dt to the accumulation time become too large to ignore its influence, the process transits to step S15 to perform gain correction for the A image signal in accordance with the shutter speed setting. That is, by correcting the A image signal using a correction coefficient k according to the shutter speed setting, the A1 image signal (=kA) increased by an increase in signal corresponding to the time difference dt is calculated.

The correction coefficient k can be decided based on the ratio of the time difference between the read-out timing of the A image signal and that of the (A1+B1) image signal. More specifically, the correction coefficient k can be decided based on the ratio between the first accumulation period until the A signal is read out and the second accumulation period until the (A1+B1) signal is read out.

For example, by preparing in advance a correction coefficient table, as shown in Table 1 below, it is possible to decide the correction coefficient k based on the referred shutter speed setting.

TABLE 1

| Shutter speed T | Correction coefficient k |
|---|---|
| 1 | 1 |
| ½ | 1 |
| ¼ | 1 |
| . | . |
| . | . |
| . | . |
| 1/128 | 1 |
| 1/512 | 1.01 |
| 1/1024 | 1.02 |
| 1/2048 | 1.04 |
| 1/4096 | 1.09 |
| 1/8192 | 1.20 |
| 1/16384 | 1.49 |

In Table 1, the shutter speed T corresponds to the accumulation period (first accumulation period) of the photoelectric conversion elements 24A and 24B until the A signal is read out. The time difference dt from acquisition of the A image signal to acquisition of the (A+B) signal is 20 μs. A shutter speed of 1/512 sec or faster corresponds to a high-speed shutter in the determination processing in step S13. A shutter speed of 1/128 sec or slower corresponds to a low-speed shutter in the determination processing in step S13.

In step S16, the B1 image signal serving as the second focal point detection signal is calculated from the A1 image signal set in step S14 or S15 and the (A1+B1) image signal acquired in step S12. The B1 image signal is calculated by subtracting the A1 image signal from the (A1+B1) image signal (B1=(A1+B1)−kA).

In step S17, phase difference detection processing is performed using the A1 image signal and the B1 image signal which have been obtained by the above-described processing. This makes it possible to acquire two focal point detection signals (A1 image signal and B1 image signal) with no output level difference. In the phase difference detection processing illustrated in FIG. 6A, a focal point detection operation with a reduced error can be performed.

Note that in the present embodiment, a case in which a focal point detection signal (A signal) and image forming signal (A1+B1 signal) are acquired has been explained. Even when two focal point detection signals (A signal and B signal) are independently read out, the same signal level correction as that in this embodiment can be performed.

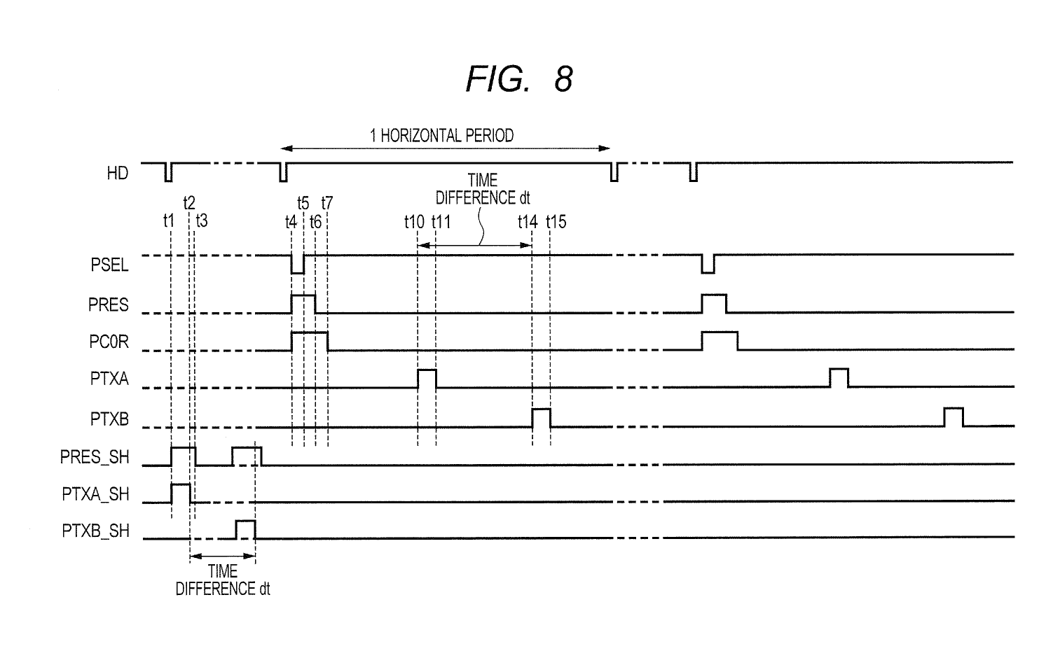

When independently reading out two focal point detection signals (A signal and B signal), it is possible to avoid the occurrence of a phase error by the following method. That is, for example, as illustrated in the timing chart of FIG. 8, the time difference dt is set between the timing of resetting the photoelectric conversion element 24A and the timing of resetting the photoelectric conversion element 24B. This can equalize the accumulation time of the photoelectric conversion element 24A until the A signal is read out and that of the photoelectric conversion element 24B until the B signal is read out, thereby preventing the occurrence of an error in focal point detection. In this method, however, when imaging a moving object, the increasing time difference dt may degrade the sharpness of an image. On the other hand, the method of driving the imaging device according to the present embodiment can prevent the occurrence of an error in focal point detection while ensuring the sharpness of an image.

As described above, according to the present embodiment, it is possible to appropriately correct an error in phase difference caused by the read-out time difference between focal point detection signals. This can implement a high-performance imaging device with improved focal point detection accuracy.

### Second Embodiment

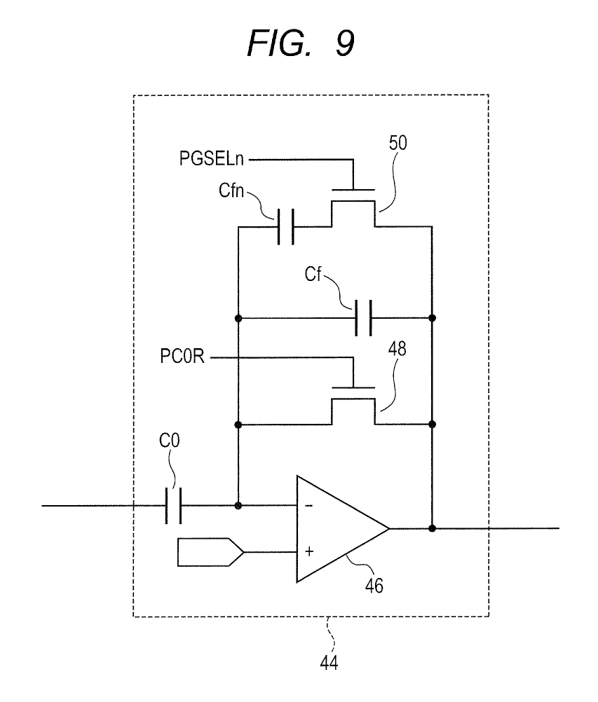

An imaging device and a method of driving the imaging device according to a second embodiment of the present invention will be described with reference to FIG. 9. The same components as those of the imaging device and the method of driving the same according to the first embodiment, which are illustrated in FIGS. 1 to 8, are denoted by the same reference numerals, and a description thereof will be omitted or made briefly.

FIG. 9 is a circuit diagram illustrating an example of the arrangement of the amplification unit 44 of the solid-state imaging element of the imaging device according to the present embodiment. In the present embodiment, gain correction processing illustrated in FIG. 7 is performed by the amplification unit 44 of each column read-out circuit 16 of the solid-state imaging element 103 instead of the camera signal processing circuit 105.

Each amplification unit 44 of the solid-state imaging element 103 includes, in a feedback path between the inverting input terminal and the output terminal of the operational amplifier 46, a load capacitor Cfn and a switch 50 which are connected to the load capacitor Cf and the switch 48 in parallel. The switch 50 is driven by a signal PGSELn applied to a control node. When the signal PGSELn is at high level, the switch 50 is rendered conductive (turned on). When the signal PGSELn is at low level, the switch 50 is rendered non-conductive (turned off).

When the switch 48 is off state, the operational amplifier 46 amplifies a signal input via an input capacitor C0 in accordance with a gain decided based on the ratio between the input capacitor C0 and the load capacitors Cf and Cfn. That is, when the switch 50 is non-conductive, the gain is C0/Cf. Alternatively, when the switch 50 is conductive, the gain is C0/(Cf+Cfn). Therefore, the output gain can be controlled by switching between the conductive state and non-conductive state of the switch 50.

Referring to FIG. 9, a pair of the load capacitor Cfn and switch 50 is connected in the feedback path between the inverting input terminal and the output terminal of the operational amplifier 46. The present embodiment is not limited to the example illustrated in FIG. 9. For example, a plurality of pairs of load capacitors Cfn and switches 50 may be connected in the feedback path. This arrangement can further increase the switching step count of the output gain, thereby improving the focal point detection accuracy at various shutter speeds.

The method of driving the imaging device according to the present embodiment will be described with reference to FIGS. 5 and 9. The driving method for the imaging device according to the present embodiment controls the signal PGSELn so that desired gains are obtained at time t10 and time t14 in accordance with the setting value of the shutter speed of the imaging device. The ratio of the output gains switched by controlling the signal PGSELn corresponds to the above-described correction coefficient k.

At time t10, the switch 50 is rendered non-conductive and the gain of the amplification unit 44 is set to C0/Cf. At time t14, the switch 50 is rendered conductive and the load capacitor Cfn is connected to the load capacitor Cf in parallel. The feedback capacitance of the operational amplifier 46 is (1/k)×(Co+Cf), and it is possible to acquire an A1 signal by amplifying an A signal by a gain which is k times larger than the gain at the time of acquiring an A1+B1 signal.

According to the present embodiment, it is possible to appropriately correct an error in phase difference caused by the read-out time difference between focal point detection signals. This can implement a high-performance imaging device with improved focal point detection accuracy.

### Third Embodiment

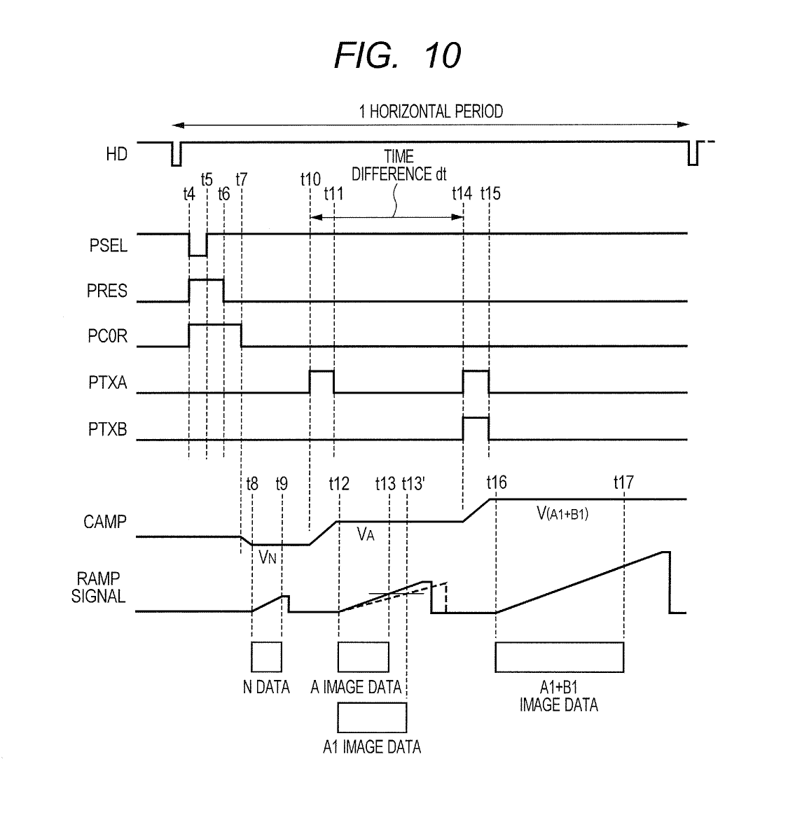

An imaging device and a method of driving the imaging device according to a third embodiment of the present invention will be described with reference to FIG. 10. The same components as those of the imaging device and the driving method therefor according to the first or second embodiment, which are illustrated in FIGS. 1 to 9, are denoted by the same reference numerals, and a description thereof will be omitted or made briefly.

FIG. 10 is a timing chart illustrating the method of driving the imaging device according to the present embodiment. In the present embodiment, gain correction processing illustrated in FIG. 7 is performed by an A/D conversion unit 52 of each column read-out circuit 16 of the solid-state imaging element 103 instead of the camera signal processing circuit 105. Referring to FIG. 10, CAMP represents the output signal of an amplification unit 44. A ramp signal is a signal whose voltage value gradually changes (increases) with time, and is supplied from the ramp signal generator 20 and input to the inverting input terminal of the operational amplifier 56 as a comparator of the A/D conversion unit 52. The ramp signal is an example of a reference signal compared with a pixel signal in the operational amplifier 56.

Processing up to time t7 is performed, similarly to the driving method for the imaging device according to the first embodiment illustrated in FIG. 5. This outputs, to the input terminal of the amplification unit 44 via a select MOS transistor 32 and vertical signal line 40, a signal (reset signal) when the input node of an amplifier MOS transistor 30 is at the potential of a reset level. Then, the reset signal amplified by a gain decided based on the ratio (C0/Cf) between the input capacitor C0 and the load capacitor Cf is output from the output terminal of the amplification unit 44. The reset signal output from the amplification unit 44 is input to the non-inverting input terminal of the operational amplifier 56 via the operational amplifier 54 serving as a buffer circuit.

After the reset signal output from the amplification unit 44 changes to a reset level VN, the ramp signal generator 20 starts, at time t8, to increase the signal level of the ramp signal to be output to the operational amplifier 56. The operational amplifier 56 compares the reset signal at the reset level VN input from the amplification unit 44 with the ramp signal supplied from the ramp signal generator 20. The ramp signal generator 20 gradually increases the level of the ramp signal from the initial voltage value in synchronism with a counter 22. When the signal level of the ramp signal reaches the same level as the reset level VN of the reset signal, the operational amplifier 56 causes the output signal to transit from low level to high level. The output value of the counter 22 latched at this timing is stored in a memory 18 as a digital code (N data) corresponding to the reset level VN of the reset signal. For example, if the signal level of the ramp signal and the reset level VN of the reset signal become equal to each other at time t9, the output value of the counter 22 at time t9 is stored in the memory 18 as N data. Note that the N data can be used to remove reset noise caused by correlation double sampling processing.

During a period from time t10 to time t11, an A signal is read out, similarly to the first embodiment. After the pixel signal output from the amplification unit 44 changes to a signal level VA, the ramp signal generator 20 starts, at time t12, to increase the signal level of the ramp signal to be output to the operational amplifier 56. The operational amplifier 56 compares the A signal at the signal level VA input from the amplification unit 44 with the ramp signal supplied from the ramp signal generator 20.

The ramp signal generator 20 gradually increases the level of the ramp signal from the initial voltage value in synchronism with the counter 22. When the signal level of the ramp signal reaches the same level as the signal level VA of the A signal, the operational amplifier 56 causes the output signal to transit from low level to high level. The output value of the counter 22 latched at this timing is stored in the memory 18 as a digital code (A image data) corresponding to the signal level VA of the A signal. For example, if the signal level of the ramp signal and the signal level VA of the A signal become equal to each other at time t13, the output value of the counter 22 at time t13 is stored in the memory 18 as A image data.

During a period from time t14 to time t15, an A1+B1 signal is read out, similarly to the first embodiment. After the pixel signal output from the amplification unit changes to a signal level V(A1+B1), the ramp signal generator 20 starts, at time t16, to increase the signal level of the ramp signal to be output to the operational amplifier 56. The operational amplifier 56 starts a comparison operation of the A1+B1 signal at the signal level V(A1+B1) input from the amplification unit 44 and the ramp signal supplied from the ramp signal generator 20.

The ramp signal generator 20 gradually increases the level of the ramp signal from the initial voltage value in synchronism with the counter 22. When the signal level of the ramp signal reaches the same level as the signal level V(A1+B1) of the A1+B1 signal, the operational amplifier 56 causes the output signal to transit from low level to high level. The output value of the counter 22 latched at this timing is stored in the memory 18 as a digital code (A1+B1 image data) corresponding to the signal level V(A1+B1) of the A1+B1 signal. For example, if the signal level of the ramp signal and the signal level V(A1+B1) of the A1+B1 signal become equal to each other at time t14, the output value of the counter 22 at time t17 is stored in the memory 18 as A1+B1 image data.

The signal level of the digital code acquired by the above-described method is decided based on a count value as the count result of the counter 22. The count value depends on the time until a signal of high level is output from the operational amplifier 56, and thus changes if the signal levels are equal to each other but the slopes of the ramp signals are different from each other. That is, even if the signal levels of the input signals are equal to each other, if the slopes of the ramp signal waveforms are different from each other, the conversion gain of the output digital code changes.

If, for example, the ramp signal for acquiring the signal A output at time t14 has a waveform more gradual than that indicated by a dotted line in FIG. 10, the time at which the signal level of the ramp signal reaches the same level as the signal level VA of the A signal is time t13′ later than time t13. As a result, the conversion gain becomes large, and the signal level of the acquired digital code increases.

Therefore, the slope of the ramp signal output from time t12 for acquiring the A signal is made smaller than that of the ramp signal output from time t16 for acquiring the (A1+B1) signal, thereby making it possible to acquire the A1 signal by performing gain correction for the A signal. That is, it is possible to perform digital gain correction of converting the digital code (A image data) corresponding to the A image signal into a digital code (A1 image data) corresponding to the A1 image signal.

That is, it is possible to perform output gain correction of a focal point detection signal by setting, as needed, the slope of the ramp signal at the time of acquiring the A signal with respect to the slope of the ramp signal at the time of acquiring the A1+B1 signal in accordance with the shutter speed setting value of the imaging device. The ratio between the slope of the ramp signal for acquiring the A signal and that of the ramp signal for acquiring the A+B signal corresponds to the above-described correction coefficient k.

As described above, according to the present embodiment, it is possible to appropriately correct an error in phase difference caused by the read-out time difference between focal point detection signals. This can implement a high-performance imaging device with improved focal point detection accuracy.

[Modifications]

The present invention is not limited to the aforementioned embodiments, and various modifications can be made.

For example, in the above embodiments, after the A signal and (A1+B1) signal are acquired, the A signal is corrected to calculate the A1 signal. However, the (A1+B1) signal may be corrected to calculate the (A+B) signal. In this case, the (A1+B1) signal need only be multiplied by a gain of 1/k. Since it is only necessary to acquire two focal point detection signals with no output level difference in signal level correction, either of the signals may be corrected. Alternatively, two signals may be corrected by different gains to acquire two focal point detection signals with no output level difference.

Gain correction of a focal point detection signal is performed by the camera signal processing circuit 105 in the first embodiment, by the amplification unit 44 in the second embodiment, and by the A/D conversion unit 52 in the third embodiment. However, two or three of the components may be combined. For example, gain correction in the amplification unit 44 and that in the camera signal processing circuit 105 may be performed, and the combination of them may implement the desired correction coefficient k. The same goes for other combinations. Each of the embodiments has exemplified a case in which each pixel includes two photoelectric conversion elements. The number of photoelectric conversion elements need not always be two, and need only be two or more.

Each of the aforementioned embodiments has mainly exemplified a case in which the photoelectric conversion elements 24A and 24B are reset at the same time. It is not always necessary to reset the photoelectric conversion elements 24A and 24B at the same time. The present invention is widely applicable when performing a read-out operation in which the accumulation period until the A signal is read out is different from that until the A+B signal or B signal is read out.

Furthermore, the arrangement of the intra-pixel read-out circuit is not limited to that illustrated in FIG. 1. The aforementioned embodiments have exemplified only several aspects to which the present invention is applicable, and do not prevent correction or modification from being performed, as needed, without departing from the spirit and scope of the present invention.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-135890, filed on Jul. 1, 2014, which is hereby incorporated by reference herein in its entirety.

What is claimed is:

1. An imaging device comprising:
a pixel including
a first photoelectric conversion element,
a second photoelectric conversion element, and
a microlens commonly provided for the first photoelectric conversion element and the second photoelectric conversion element;
a read-out circuit configured to
reset the first photoelectric conversion element and the second photoelectric conversion element,
read out a first focal point detection signal based on signal charges generated in the first photoelectric conversion element, and
read out, after the first focal point detection signal is read out, a second focal point detection signal based on signal charges generated in at least the second photoelectric conversion element; and
a correction unit configured to correct at least one of the first focal point detection signal and the second focal point detection signal in accordance with a time difference between a timing of the read-out of the first focal point detection signal and a timing of the read-out of the second focal point detection signal.

2. The imaging device according to claim 1, wherein
the correction unit performs gain correction for at least one of output values of the first focal point detection signal and the second focal point detection signal in accordance with a ratio between a length of a first accumulation period and a length of a second accumulation period, the first accumulation period being a period from the reset of the first photoelectric conversion element to the read-out of the first focal point detection signal, the second accumulation period being a period from the reset of the second photoelectric conversion element to the read-out of the second focal point detection signal.

3. The imaging device according to claim 1, further comprising:
an amplifier configured to amplify a signal read out from the pixel,
wherein the correction unit performs gain correction by switching a gain of the amplifier, the gain correction being for at least one of the output values of the first focal point detection signal and the second focal point detection signal.

4. The imaging device according to claim 1, further comprising:
an A/D converter configured to convert an analog signal read out from the pixel into a digital signal,
wherein the correction unit performs gain correction by switching a conversion gain when A/D-converting the first focal point detection signal and the second focal point detection signal, the gain correction being for at least one of the output values of the first focal point detection signal and the second focal point detection signal.

5. The imaging device according to claim 1, wherein
a correction coefficient at the time of correcting at least one of the first focal point detection signal and the second focal point detection signal is determined based on a ratio of the time difference with respect to a shutter speed.

6. The imaging device according to claim 1, wherein
the second focal point detection signal is based on signal charges generated by adding the signal charges generated in the first photoelectric conversion element and the signal charges generated in the second photoelectric conversion element.

7. The imaging device according to claim 6, wherein
the second focal point detection signal is used for generating an image and detecting a focal point.

8. The imaging device according to claim 1, wherein
the second focal point detection signal is based on the signal charges generated only in the second photoelectric conversion element.

9. An imaging device comprising:
a pixel including
a first photoelectric conversion element,
a second photoelectric conversion element, and
a microlens commonly provided for the first photoelectric conversion element and the second photoelectric conversion element; and
a read-out circuit configured to
reset the first photoelectric conversion element,
reset the second photoelectric conversion element,
read out a first focal point detection signal based on signal charges generated in the first photoelectric conversion element, and
read out, after the first focal point detection signal is read out, a second focal point detection signal based on signal charges generated in at least the second photoelectric conversion element,
wherein the read-out circuit is further configured to control a reset timing and a read-out timing so that a time difference between the reset of the first photoelectric conversion element and the reset of the second photoelectric conversion element is equal to a time difference between the read-out of the first focal point detection signal and the read-out of the second focal point detection signal.

10. A method of driving an imaging device having a pixel including a first photoelectric conversion element, a second photoelectric conversion element, and a microlens configured to focus incident light on the first photoelectric conversion element and the second photoelectric conversion element, the method comprising:
resetting the first photoelectric conversion element and the second photoelectric conversion element;
reading out a first focal point detection signal based on signal charges generated in the first photoelectric conversion element;
reading out, after the first focal point detection signal is read out, a second focal point detection signal based on signal charges generated in at least the second photoelectric conversion element; and
correcting at least one of the first focal point detection signal and the second focal point detection signal in accordance with a time difference between a timing of the read-out of the first focal point detection signal and a timing of the read-out of the second focal point detection signal.

11. An imaging device comprising:
a pixel including
a first photoelectric conversion element configured to generate a first charge by photoelectric conversion,
a second photoelectric conversion element configured to generate a second charge by photoelectric conversion,
an amplifier transistor,
a first transfer transistor configured to be connected to the first photoelectric conversion ant the amplifier transistor,
a second transfer transistor configured to be connected to the second photoelectric conversion element and the amplifier transistor, and
a microlens commonly provided for the first photoelectric conversion element and the second photoelectric conversion element;
a read-out circuit configured to
reset the first photoelectric conversion element and the second photoelectric conversion element,
transfer the first charge from the first photoelectric conversion element to the amplifier transistor via the first transfer transistor, and
transfer, after the first charge from the first photoelectric conversion element is transferred to the amplifier transistor, the second charge from the second photoelectric conversion element to the amplifier transistor via the second transfer transistor; and
a correction unit configured to correct at least one of a first signal based on the first charge and a second signal based on the second charge in accordance with a time difference between a timing of transferring the first charge from the first photoelectric conversion element to the amplifier transistor and a timing of transferring the second charge from the second photoelectric conversion element to the amplifier transistor.

12. The imaging device according to claim 11, wherein
the correction unit performs gain correction for at least one of output values of the first signal and the second signal in accordance with a ratio between a length of a first accumulation period and a length of a second accumulation period, the first accumulation period being a period from the reset of the first photoelectric conversion element to the transfer the first charge from the first photoelectric conversion element to the amplifier transistor, the second accumulation period being a period from the reset of the second photoelectric conversion element to the transfer the second charge from the second photoelectric conversion element to the amplifier transistor.

13. The imaging device according to claim 11, further comprising:
an amplifier configured to amplify a signal read out from the pixel,
wherein the correction unit performs gain correction by switching a gain of the amplifier, the gain correction being for at least one of the output values of the first signal and the second signal.

14. The imaging device according to claim 11, further comprising:
an A/D converter configured to convert an analog signal read out from the pixel into a digital signal,
wherein the correction unit performs gain correction by switching a conversion gain when A/D-converting the first focal point detection signal and the second focal point detection signal, the gain correction being for at least one of the output values of the first focal point detection signal and the second focal point detection signal.

15. The imaging device according to claim 11, wherein
a correction coefficient at the time of correcting at least one of the first signal and the second signal is determined based on a ratio of the time difference with respect to a shutter speed.

16. The imaging device according to claim 11, wherein
the second signal is based on a charge generated by adding the first charge and the second charge.

17. The imaging device according to claim 11, wherein
the second signal is used for generating an image and detecting a focal point.

18. The imaging device according to claim 11, wherein
the second focal point detection signal is based on the signal charges generated only in the second photoelectric conversion element.
